(19) United States
(12) Patent Application Publication
(10) Pub. No.: US 2012/0057342 A1
(43) Pub. Date: Mar. 8, 2012

(54) Article having back light

(76) Inventor: Jen Shieh Shih, Changhua (TW)

(21) Appl. No.: 12/807,536

(22) Filed: Sep. 8, 2010

(51) Int. Cl. F21V 8/00

(52) U.S. Cl. 362/235; 362/311.01

(57) ABSTRACT

An article includes a light guide member having an inclined surface and one or more cavities formed in the rear portion, a circuit board is disposed in front of the light guide member and having one or more light sources directed toward the cavities of the light guide member, and a cover member is disposed in front of the circuit board and the light guide member, and the cavities of the light guide member refract the light generated by the light sources toward the inclined surface of the light guide member for generating a back light on the outer peripheral portion of the light guide member and the cover member and for allowing the article to be clearly seen in the dark area or in the dark environment.

### BACKGROUND OF THE INVENTION

1. Field of the Invention

The present invention relates to a mark or decorative article, and more particularly to a mark or decorative article including a back light for lighting the peripheral contour of the article and for allowing the article to be suitably seen in the dark area or in the dark environment.

2. Description of the Prior Art

Typical reflective or decorative articles comprise one or more light bulbs or light sources, and one or more light pipe guides aligned with or disposed in front of the light bulbs or light sources for transmitting the activity lights generated or emitted from the light bulbs or light sources and for displaying at the front bezel for viewing by the user.

For example, U.S. Pat. No. 5,988,842 to Johnsen et al., U.S. Pat. No. 6,231,224 to Gamble et al., and U.S. Pat. No. 6,431,718 to Gamble et al. disclose several of the typical apparatuses for showing light at a distance from a light source, with light pipe guides.

However, normally, the light pipe guides are disposed in front of the light bulbs or light sources for directly transmitting the activity lights generated or emitted from the light bulbs or light sources, but may not be used to refract the activity lights to form the back light for the apparatuses or articles.

The present invention has arisen to mitigate and/or obviate the afore-described disadvantages of the conventional reflective or decorative articles.

### SUMMARY OF THE INVENTION

The primary objective of the present invention is to provide a mark or decorative article including a back light for lighting the peripheral contour of the article and for allowing the article to be suitably seen in the dark area or in the dark environment.

In accordance with one aspect of the invention, there is provided an article comprising a light guide member including a front portion, and including a rear portion having an inclined surface formed in an outer peripheral portion thereof, and including at least one cavity formed in the rear portion of the light guide member, a circuit board disposed in front of the light guide member, and including a light source directed toward the cavity of the light guide member, and a cover member disposed in front of the circuit board and the light guide member, and the cavity of the light guide member refracts a light generated by the light source toward the inclined surface of the light guide member for generating a back light on the outer peripheral portion of the light guide member and the cover member and for allowing the article to be suitably or clearly seen in the dark area or in the dark environment.

The light guide member includes at least one V-shaped notch formed in the rear portion of the light guide member for refracting the light refracted from the cavity of the light guide member and for generating a back light in the light guide member.

The light guide member includes at least one forwardly protruded rib, and the V-shaped notch of the light guide member is located behind the rib, and preferably slightly offset from the rib for refracting the light.

The cover member includes an orifice formed therein, and a light guide element is disposed behind the cover member and includes a protrusion extended forwardly therefrom and engaged into the orifice of the cover member.

The circuit board includes a front portion and includes at least one second light source disposed on the front portion of the circuit board, and a light refractive member is disposed behind the protrusion of the light guide element and disposed beside the second light source and includes a light refractive surface for refracting the light toward and through the protrusion of the light guide element.

The circuit board includes one or more fins extended forwardly from the front portion thereof, and the second light source is attached to the fins and disposed or located beside the light refractive member. The circuit board includes a reflector disposed beside the light refractive member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front plan schematic view of an article in accordance with the present invention;

FIG. 2 is an exploded view of the article;

FIG. 3 is a rear perspective view illustrating a light guide member of the article;

FIG. 4 is a cross sectional view of the article taken along lines 4-4 of FIG. 1;

FIG. 5 is an enlarged partial cross sectional view of the article as shown in FIG. 4, illustrating the operation of the article;

FIG. 6 is another cross sectional view of the article taken along lines 6-6 of FIG. 1; and

FIG. 7 is an enlarged partial cross sectional view of the article as shown in FIG. 6, illustrating the operation of the article.

### DETAILED DESCRIPTION OF THE PREFERRED EMBODIMENT

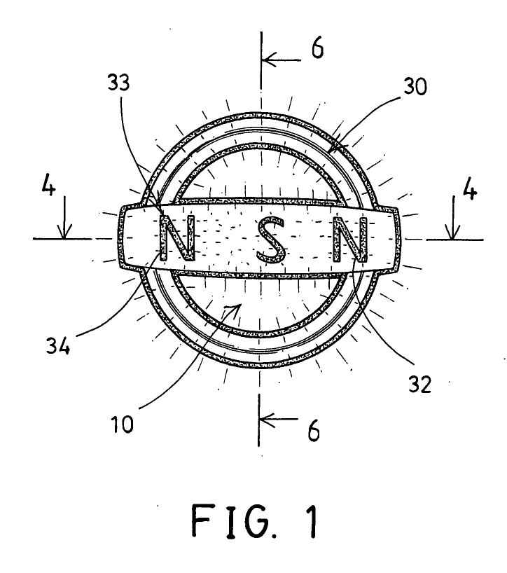

Referring to the drawings, and initially to FIGS. 1-4, and 6 a mark or decorative article in accordance with the present invention comprises a base or light guide member 10 including a peripheral flange 11 extended forwardly from the outer peripheral portion thereof, and/or including one or more forwardly protruded ribs 12 for forming or defining a chamber 13 therein or between or within the peripheral flange 11 and/or the peripheral ribs 12, or in the front portion 14 of the light guide member 10, and including a tilted or inclined surface 15 formed in the outer peripheral portion of the rear portion 16 thereof for light refractive purposes, and including one or more V-shaped notches 17 also formed in the rear portion 16 thereof for light refractive purposes and located behind the ribs 12 and slightly offset from the ribs 12, and including one or more cone-shaped cavities 18 also formed in the rear portion 16 thereof for light refractive purposes.

A circuit board 20 is disposed or engaged into the chamber 13 of the light guide member 10, and includes one or more light bulbs or light sources 21, such as light emitting diodes 21 disposed in the rear portion 22 thereof and faced or directed toward the front portion 14 of the light guide member 10, and aligned with or disposed in front of the cavities 18 of the light guide member 10 which may refract the light generated or emitted from the light sources 21 (FIG. 7), and includes one or more (such as two) fins 23 extended forwardly from the front portion 24 thereof and preferably arranged and faced toward each other, and includes one or more further light bulbs or light sources 25, such as light emitting diodes 25 disposed or attached or mounted or secured to the fins 23 and preferably arranged and faced toward each other.

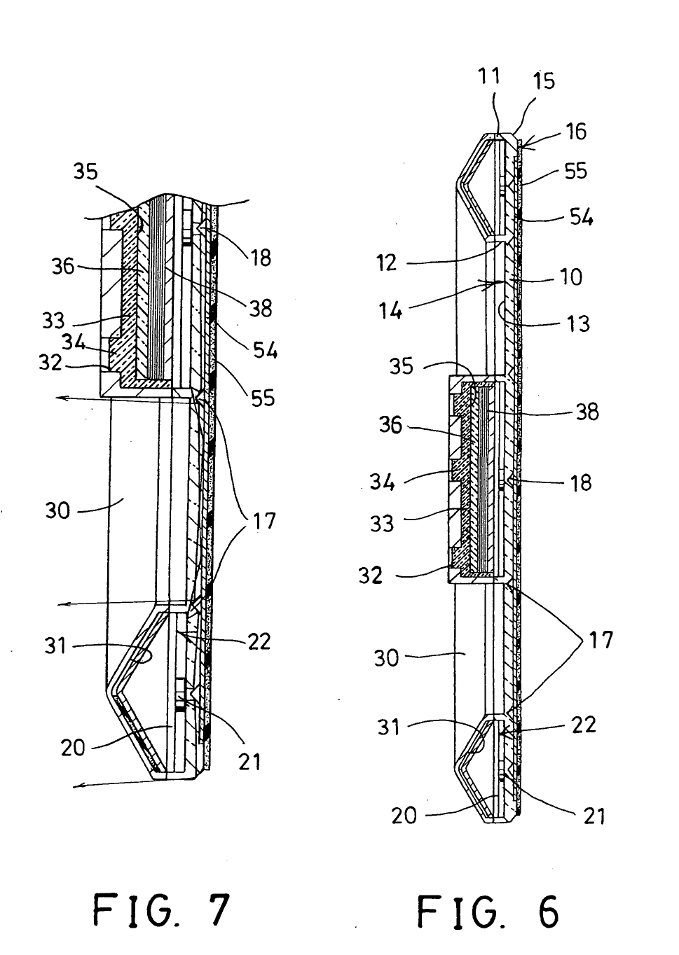

In operation, as shown in FIGS. 6 and 7, the light generated or emitted by the light sources 21 is directed toward the cavities 18 of the light guide member 10 which may refract the light toward the V-shaped notches 17 and/or the tilted or inclined surface 15 of the light guide member 10, and the V-shaped notches 17 and/or the tilted or inclined surface 15 of the light guide member 10 may then refract the light sidewise or laterally for generating a back light on the outer peripheral portion and/or the inner peripheral portion of the light guide member 10, and/or for generating the back light on the marginal portion of the light guide member 10 (FIG. 1). It is to be noted that the light sources 21 are disposed in front of the light guide member 10 and directed toward the cavities 18 of the light guide member 10 in order to refract the light sidewise or laterally with the V-shaped notches 17 and/or the tilted or inclined surface 15 of the light guide member 10.

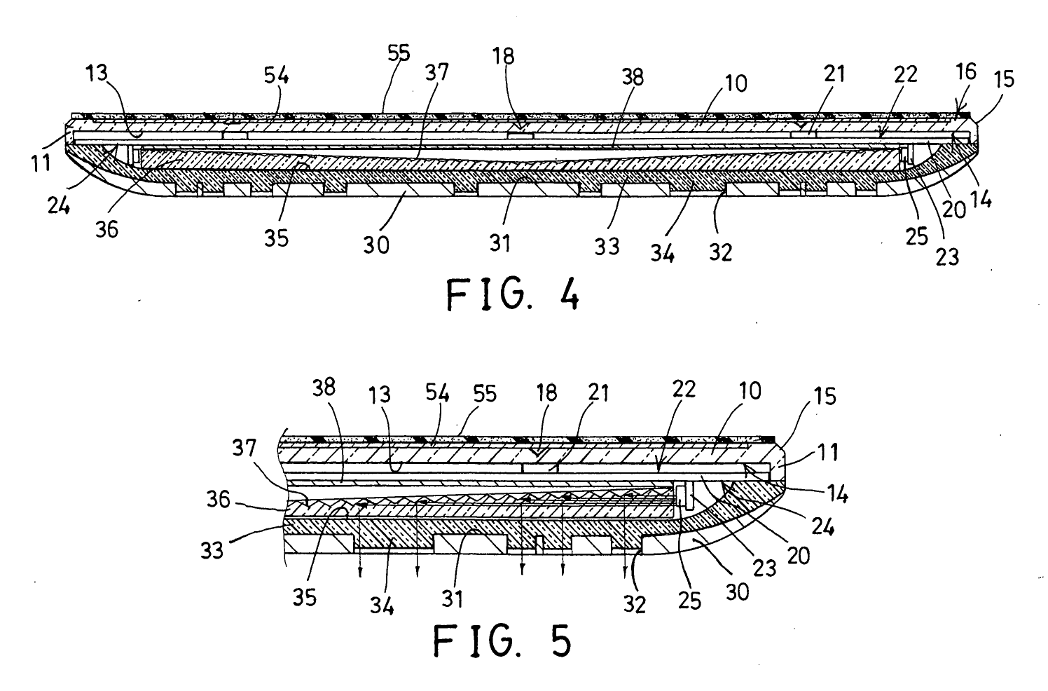

A cover member 30 is disposed or attached or mounted or secured onto the front portion 14 of the light guide member 10, and/or engaged with the peripheral flange 11 of the light guide member 10 (FIG. 6), or disposed in front of the circuit board 20, and includes a compartment 31 formed therein, and includes one or more orifices 32 formed therein and aligned with or communicative with the compartment 31 thereof, it is preferable that the orifices 32 of the cover member 30 are arranged or formed as various decorative patterns, marks, or words or the like. Another light guide element 33 includes a shape identical or similar to that of the compartment 31 of the cover member 30 for engaging into the compartment 31 of the cover member 30 and secured to the cover member 30 with such as adhesive materials 80, and includes one or more protrusions 34 extended forwardly therefrom and engaged into the orifices 32 of the cover member 30 respectively (FIGS. 4-6), and includes a space 35 formed therein.

A light refractive member 36 is disposed or engaged into the space 35 of the light guide element 33, and disposed or located or engaged between the light sources 25 or the fins 23 of the circuit board 20 for transmitting the activity lights generated or emitted from the light sources 25 (FIG. 5), and includes a notched or serrated or grooved light refractive surface 37 formed therein, such as formed in the rear portion thereof and faced or directed toward the front portion 14 of the light guide member 10 for transmitting and refracting the light toward or through the protrusions 34 of the light guide element 33 (FIG. 5), and includes a reflective element or reflector 38 also disposed or engaged into the space 35 of the light guide element 33, and disposed or located or engaged between the light refractive member 36 and the circuit board 20 for further reflecting the light toward or through the protrusions 34 of the light guide element 33.

In operation, as shown in FIGS. 4 and 5, the light generated or emitted by the light sources 25 is directed toward the light refractive member 36, and the light refractive surface 37 of the light refractive member 36 may refract the light toward the protrusions 34 of the light guide element 33 and through the orifices 32 of the cover member 30 for allowing the decorative patterns, marks, or words or the like formed by the protrusions 34 of the light guide element 33 and/or the orifices 32 of the cover member 30 to be seen by the user (FIG. 1). It is to be noted that the light sources 25 are disposed on the side or outer peripheral portion of the light refractive member 36, and the light refractive surface 37 of the light refractive member 36 may refract the light in a direction perpendicular to the light refractive member 36 and toward the protrusions 34 of the light guide element 33 and through the orifices 32 of the cover member 30. The reflective element or reflector 38 may further reflect the light toward or through the light refractive member 36.

It is further to be noted that the light guide member 10 is disposed or located behind the cover member 30 and covered or shielded by the cover member 30, or the cover member 30 is disposed or located in front of the light guide member 10, however, the light generated or emitted from the light sources 21 and refracted by the cavities 18 of the light guide member 10 and then refracted by the V-shaped notches 17 and/or the tilted or inclined surface 15 of the light guide member 10 may also generate the back light on the marginal portion of the cover member 30 and for allowing the marginal portion of the cover member 30 and/or the protrusions 34 of the light guide element 33 and/or the orifices 32 of the cover member 30 to be suitably or clearly seen in the dark area or in the dark environment.

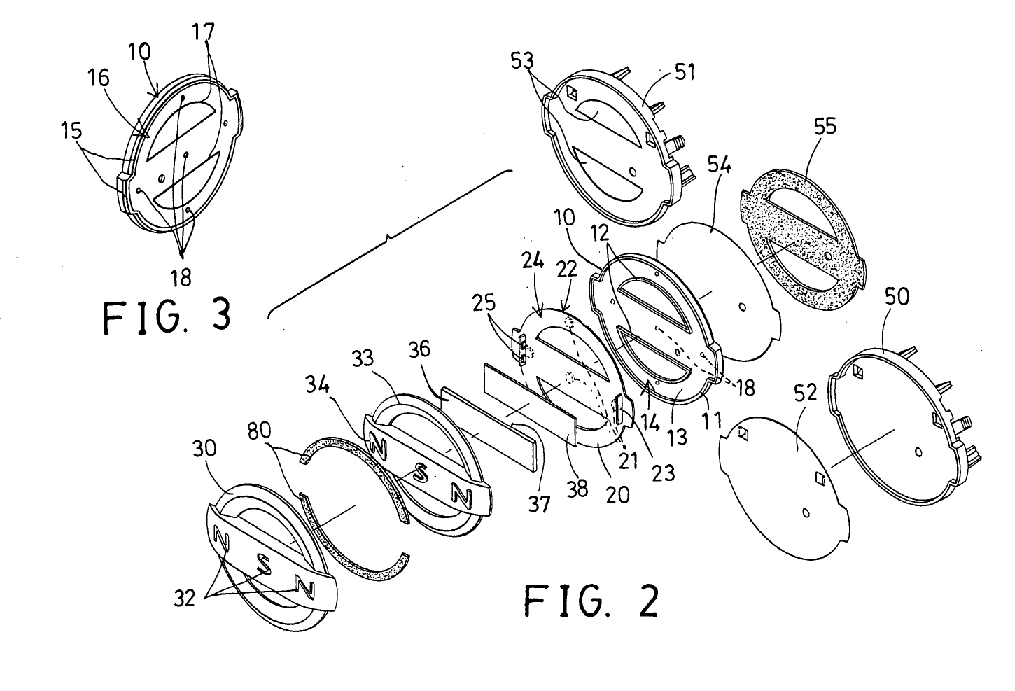

As shown in FIG. 2, one or more carriers or housings 50, 51 may further be provided for receiving or engaging with the light guide member 10 and the cover member 30 and for attaching or mounting or securing or coupling the light guide member 10 and the cover member 30 and the housings 50, 51 to various kinds of vehicles or the like, the housings 50, 51 each may include a base or insert 52 that may include various marks, or words or decorative patterns 53, or the like applied thereon, the light guide member 10 may further include a base panel 54 and attached or mounted or secured to the housings 50, 51 with such as adhesive materials 55, in which the housings 50, 51 and the insert 52 and the base panel 54 are not related to the present invention and will not be described in further details.

Accordingly, the mark or decorative article in accordance with the present invention includes a back light for lighting the peripheral contour of the article and for allowing the article to be suitably or clearly seen in the dark area or in the dark environment.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An article comprising:
a light guide member including a front portion, and including a rear portion having an inclined surface formed in an outer peripheral portion thereof, and including at least one cavity formed in said rear portion of said light guide member,
a circuit board disposed in front of said light guide member, and including a light source directed toward said at least one cavity of said light guide member, and
a cover member disposed in front of said circuit board and said light guide member, and
said at least one cavity of said light guide member refracting a light generated by said light source toward said inclined surface of said light guide member for generating a back light on the outer peripheral portion of said light guide member and said cover member.

2. The article as claimed in claim 1, wherein said light guide member includes at least one V-shaped notch formed in said rear portion of said light guide member for refracting the light refracted from said at least one cavity of said light guide member.

3. The article as claimed in claim 2, wherein said light guide member includes at least one forwardly protruded rib, and said at least one V-shaped notch of said light guide member is located behind said rib.

4. The article as claimed in claim 1, wherein said cover member includes an orifice formed therein, and a light guide element is disposed behind said cover member and includes a protrusion extended forwardly therefrom and engaged into said orifice of said cover member.

5. The article as claimed in claim 4, wherein said circuit board includes a front portion and includes at least one second light source disposed on said front portion of said circuit board, and a light refractive member is disposed behind said protrusion of said light guide element and disposed beside said at least one second light source and includes a light refractive surface for refracting the light toward and through said protrusion of said light guide element.

6. The article as claimed in claim 5, wherein said circuit board includes a fin extended forwardly from said front portion thereof, and said at least one second light source is attached to said fin.

7. The article as claimed in claim 5, wherein said circuit board includes a reflector disposed beside said light refractive member.
